(19) United States
(12) Patent Application Publication
(10) Pub. No.: US 2010/0017092 A1
(43) Pub. Date: Jan. 21, 2010

(54) HYBRID FAULT ISOLATION SYSTEM UTILIZING BOTH MODEL-BASED AND EMPIRICAL COMPONENTS

(76) Inventor: Steven Wayne Butler, Columbia, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/174,015

(22) Filed: Jul. 16, 2008

(51) Int. Cl. G06F 19/00

(52) U.S. Cl. 701/100; 702/185

(57) ABSTRACT

A method of operating and a fault diagnosis system compares readings to predicted faults using a model-based component, and a database of previous actual fault examples. A predicted fault is provided to an output based upon a combination of both the model-based component and the actual fault examples.

### BACKGROUND OF THE INVENTION

This application relates to a fault diagnosis system.

Fault diagnosis of a gas turbine engine consists of two discrete stages, fault detection and fault isolation. Typically, these systems identify faults, and provide a maintenance worker with a likely location for a fault, based upon a particular set of sensed system conditions.

A fault detection algorithm is responsible for monitoring engine sensors for sudden changes, which would indicate some amount of damage may have been sustained by the engine. The magnitude of the change in each sensor is passed on to a fault isolator, which determines the likely cause of the measured shift in the sensor readings. The fault isolator then directs a ground technician to the likely location of the damage. One type of fault isolation for a gas turbine engine is model-based. In such systems, a number of sensed conditions are developed, and a corresponding fault is predicted. These systems are often not based upon real world cases, but rather on computer modeling. In such systems, a vector of expected measurement shift magnitudes is created for each possible fault type. The measurement shift magnitudes represent the change in operating parameters that should correspond to that particular fault, and should be seen by the relevant sensors. These sets of measurement shift magnitudes are referred to as “fault signatures.” A set of example faults and corresponding measured changes are provided in FIG. 1. Each value listed in FIG. 1 represents the sensed shift from a normal operating condition. Of course, these numbers are all simple examples.

In order to determine a cause of a sudden change in engine performance, the fault signatures of FIG. 1 are each projected onto a vector of measurement shift magnitudes. A measurement error is then calculated for each fault as the norm of the difference of the vectors, normalized by the measurement variance of each sensor. Mathematically, a measurement error can be calculated utilizing the following expression:

$$\sqrt{{\sum }_{i = 1}^{m} {( \frac{{Measurement}_{i} - {FaultSignature}_{i}}{{SensorNoise}_{i}} )}^{2}} \qquad ( 1 )$$

where Measurementᵢ is the measurement for sensor i from the engine to be isolated, FaultSignatureᵢ is a fault signature from the engine model for sensor i, SensorNoiseᵢ is the standard deviation of the measurements for sensor i, and m is the total number of sensors monitored.

In typical systems, there may be on the order of 30 faults that must be distinguished by the eight sensors. It is inevitable that some fault signatures will appear very similar to others. These ambiguities reduce the overall accuracy of the system in certain regions of the input space. The isolation accuracy is further limited by the absence of a magnitude range for each fault type. For example, two different bleed faults may effect the gas-path measurements of an engine similarly (i.e., the normalized vector length of the fault signatures for both faults is very similar), but the two faults may be effectively differentiated by the magnitude of the shifts. Unfortunately, the measurement error calculated in Equation 1 considers only the direction of the vector, resulting in two seemingly identical faults. Finally, the described model-based isolation approach is an effective means of performing isolation without any a posteriori performance data from a revenue-service engine, but it does not easily adapt to compensate for inaccuracies in the model determined from future revenue-service data.

Although a model-based approach to isolation, which is popular in the gas-turbine field, is discussed above, a known alternative approach is to implement an empirical system. In an empirical fault isolator, a generic computer or mathematical algorithm is presented with a large set of example fault cases, collected from real world operation. From this data, the algorithm learns how to distinguish possible faults without any prior knowledge of the true engine model. These approaches are somewhat limited, especially early in the development of a new engine, when there are limited real world data points available. An empirical technique can still be implemented and trained using “synthetic” data generated by adding a reasonable amount of noise to a known engine model. The advantage is that additional training data may be added to the system in the future so that the learned model better matches the true system behavior, but the storage requirements for the generated synthetic data is much greater for a statistically representative training set than the single point required by the model for each fault. Additionally, this is a sub-optimal approach over the model-based approach because the synthetic data generated is basically a corrupt or distorted version of a precise model.

For example, one probabilistic neural network (PNN) is based on the use of Parzen windows to approximate arbitrary probability distributions. Training a PNN is as simple as storing the input data and fault labels in memory. There is no transformation or optimization of the data required, allowing new data points to be added to the system without “retraining” the network, which would likely require significant validation to assure that the performance was not drastically affected. Once the training data is stored, an unknown data point is evaluated by first calculating the squared distance between the unknown point and each of the stored points.

$${D}_{j}^{2} = {\sum }_{i = 1}^{N} {( {Z}_{i} - {Zmem}_{j , i} )}^{2} , \qquad ( 2 )$$

where Z is the unknown input vector, Zmemⱼ is the j^{th} stored training vector. This distance is then applied to the Parzen window, in this case a Gaussian function.

$${φ}_{j} = \frac{1}{σ \sqrt{2 π}} {e}^{( \frac{- {D}_{j}^{2}}{2 {σ}^{2}} )} , \qquad ( 3 )$$

where the σ parameter is used to adjust the width of the Gaussian. We now use these Gaussian values to calculate the probability that the unknown vector is a member of each fault class.

$$P ( Class ) = \frac{{\sum }_{i} {w}_{i} {φ}_{i}}{{\sum }_{j} {φ}_{j}} , {w}_{i} = \{ \begin{matrix}1 & Class = Ymem ( i ) \\ 0 & Class \neq Ymem ( i )\end{matrix} , \qquad ( 4 )$$

where w is a weighting vector equal to one only for values of φ corresponding to the desired class. This calculation is repeated for all classes and the class with the highest probability is the most likely prediction.

Because all of the training data points for a PNN system are stored and processed for every input data point, the storage and processing time increases significantly if trained using synthetic data, while providing only degraded isolation performance based on a degraded system model.

### SUMMARY OF THE INVENTION

A method of operating and a fault diagnostic system that includes a plurality of sensors providing readings to a fault isolation system. The fault isolation system compares the readings to predicted faults using a hybrid fault isolator formed by mathematically combining both a model-based fault isolation system and an empirical fault isolation system using a database of previous actual fault examples that are queried to compare the readings. The fault isolation system provides a predicted fault to an output from the hybrid fault isolator based upon both a model-based fault isolation system and actual fault examples.

These and other features of the present invention can be best understood from the following specification and drawings, the following of which is a brief description.

### BRIEF DESCRIPTION OF THE DRAWINGS

FIG. 1 is a graph showing a plurality of potential faults, and a plurality of sensed conditions that might be indicative of those faults.

FIG. 2A shows a vector model.

FIG. 2B is a flow chart.

FIG. 3 is an example of the integration of distances between a point and the points on a line with a Gaussian kernel applied.

FIG. 4A is an example of the integration of distances between an inside point and the points on a line segment with a Gaussian kernel applied.

FIG. 4B is an example of the integration of distances between an outside point and the points on a line segment with a Gaussian kernel applied.

### DETAILED DESCRIPTION OF THE PREFERRED EMBODIMENT

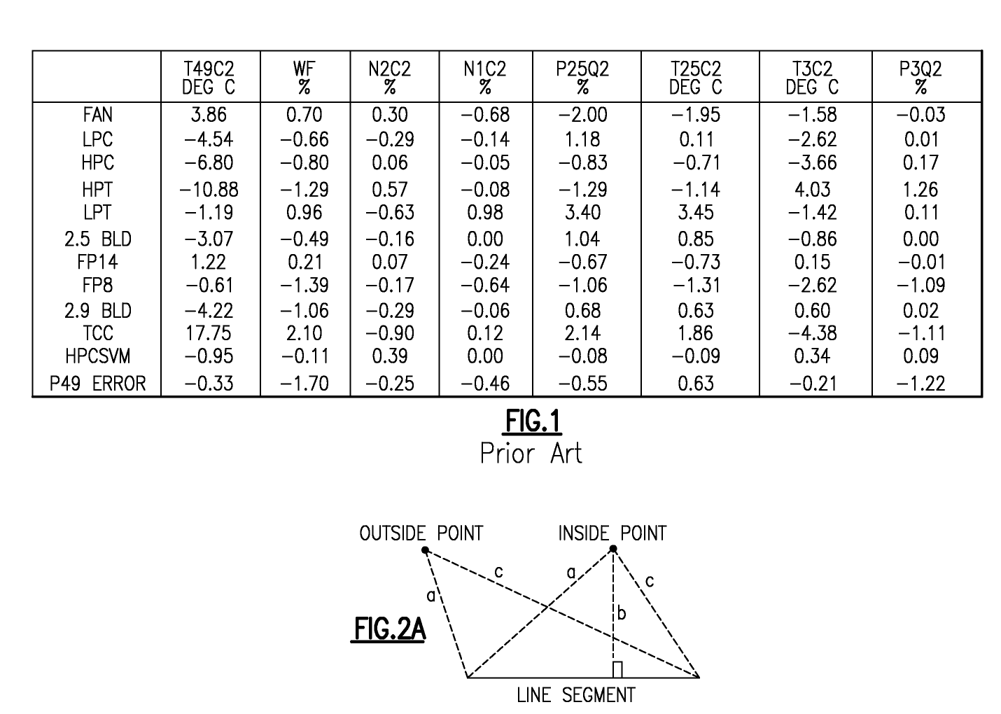

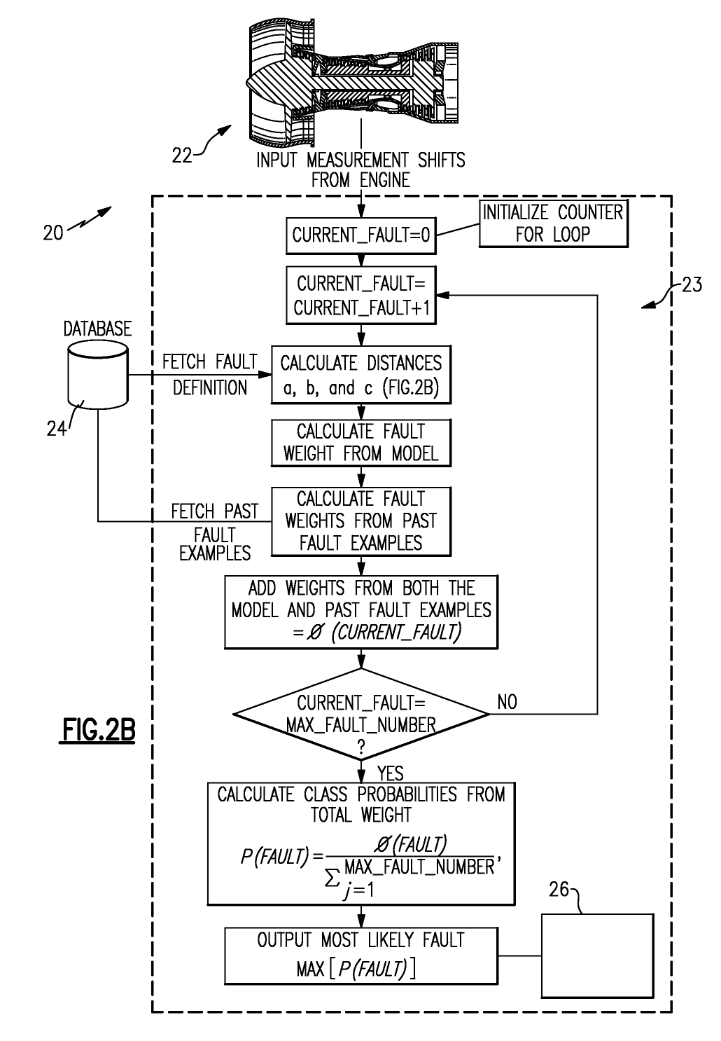

FIGS. 1, 2A and 2B outline a system for isolating a fault.

A system model, such as the model used in a model-based isolation system, is adapted to fit the mathematical architecture of an empirical isolation system. The resulting isolation system retains the benefits of both model-based and empirical architectures. In an embodiment, both the model-based and PNN architectures described in the background section are combined. The resulting system retains the low storage space, fast processing, and model precision of the model-based isolator while adding the adaptability of a model to revenue service data of an empirical isolator.

The process of developing a hybrid fault isolation system begins by adapting the model to an expression congruent with the mathematics behind the target empirical isolator. The Probabilistic Neural Network, for example, is well suited to the model format described above. A PNN network consists of a number of data points representing each possible fault type, where the distance from each stored data point to a new measurement determines the likelihood of each possible fault as the cause.

Currently the model expresses each fault as an infinite line passing through the origin of the measurement space. The similarity of this model to a PNN representation is apparent if you consider each line as an infinite number of data points along the line. One calculates the distance of a point on the line in the measurement space to each of these infinite points, applies a Gaussian kernel function, and adds the values

$$\begin{matrix}{D}_{j}^{2} = {\sum }_{i = 1}^{N} {( {Z}_{i} - {Zmem}_{j , i} )}^{2} , & ( 5 ) \\ {φ}_{j} = \frac{1}{σ \sqrt{2 π}} {\sum }_{j = - ∞}^{∞} {e}^{( \frac{- {D}_{j}^{2}}{2 {σ}^{2}} )} Δ x ⇒ \frac{1}{σ \sqrt{2 π}} {\int }_{- ∞}^{∞} {e}^{( \frac{- {D}^{2}}{2 {σ}^{2}} )} d D , & ( 6 )\end{matrix}$$

where the variable names are as defined in Equations 2-4 and Δx is the distance between the points on the infinite line (approaching zero). The result will be similar to the integration of a Gaussian PDF. If the measurement point is moved off the line to a distance d, the integration now includes all points along the PDF except for the points from −d to d, as shown in FIG. 3, where only the shaded region is integrated.

Although a large number of data points could be stored to approximate this infinite line, the processing and storage overhead required to evaluate 30 such lines would be immense. Instead, the invention takes advantage of the similarity of the math above to the integration of the Gaussian PDF. Maintaining the infinite line model for the moment, one may evaluate the model in terms of the PNN methodology by calculating the distance of the input measurement point to each line, dⱼ. The weight for each fault is then calculated as:

$${φ}_{j} == \frac{2}{σ \sqrt{2 π}} {\int }_{d}^{∞} {e}^{( - \frac{{x}^{2}}{2 {σ}^{2}} )} d x = 2 Q ( {d}_{j} ) , \qquad ( 7 )$$

where x is the distance to each of the infinite points. Finally, the probability of each fault is calculated as before:

$$P ( Class ) = \frac{{\sum }_{i} {w}_{i} {φ}_{i}}{{\sum }_{j} {φ}_{j}} , {w}_{i} = \{ \begin{matrix}1 & Class = i \\ 0 & Class \neq i\end{matrix} , \qquad ( 8 )$$

where P(Class) is the probability of each fault class.

The resulting system will provide the same results as the original model-based classifier using the very same influence coefficients as shown in FIG. 1. However, one can now add empirical data points to the system by modifying the last equation above as follows:

$$P ( Class ) = \frac{{w}_{Class} {φ}_{Class} + \frac{1}{σ \sqrt{2 π}} {\sum }_{k} {e}^{( \frac{- {D}_{k}^{2}}{2 {σ}^{2}} )}}{{\sum }_{j} {ω}_{j} {φ}_{j} + \frac{1}{σ \sqrt{2 π}} {\sum }_{i} {e}^{( \frac{- {D}_{i}^{2}}{2 {σ}^{2}} )}} , , \qquad ( 9 )$$

where D² is the squared distance to an empirical data point, the subscript k represents all empirical data points of fault Class, subscript i represents all empirical data points, subscript j represents all model vectors, and ω is a weighting factor applied to each of the model vectors, φ. With this new equation, the addition of empirical data points to the stored model vectors will influence the original model predictions towards real-world experience from the field. Over time, the empirical data will become increasingly significant to the resulting prediction, which will be more accurate to the true system in regions of the measurement space where empirical points are numerous. This will de-emphasize the assumptions made when creating the original system model.

As a result of these modifications to the PNN algorithm, we have an isolation algorithm that will perfectly match the system simulation model performance with no real-world measurement data required. Additionally, any inaccuracies in the isolator may be compensated for easily, as soon as field data becomes available, no matter how small the sample data set. Finally, the integration of the original system model into the PNN framework only requires a single data point for each expected fault, rather than the large quantity of noisy simulated data points that would otherwise be necessary to train an empirical system from a model. The data storage requirements for the empirical model representation are thus reduced and the processing speed is greatly increased.

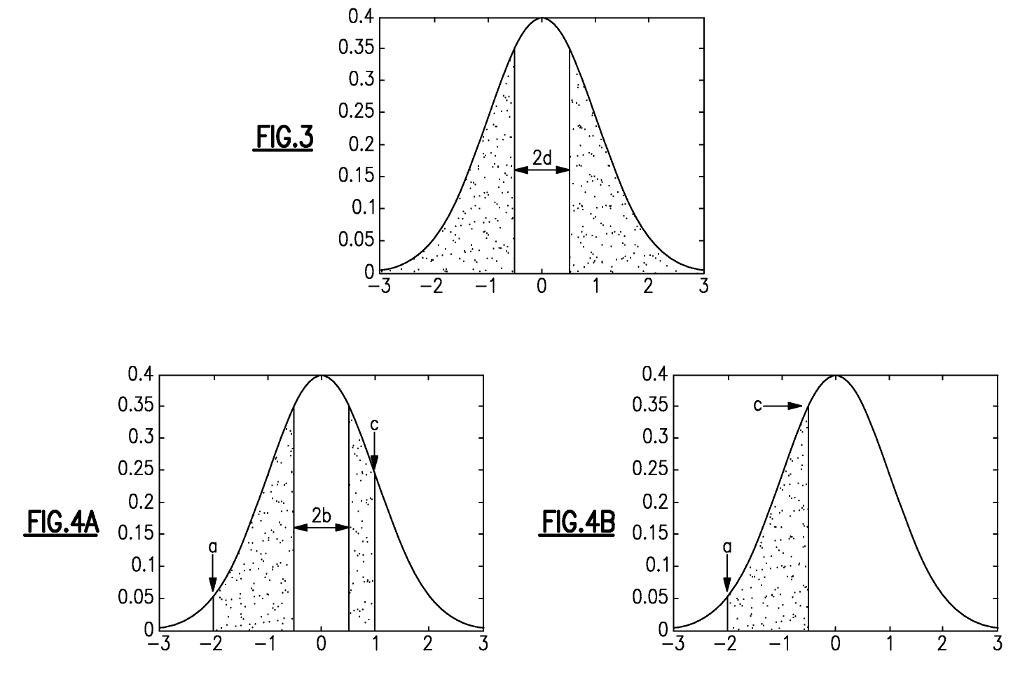

The linear model assumption from the original model can now be further relaxed by reducing each infinite model line to one or more line segments, each defined by the two end points. In order to accomplish this, the calculations of the model portion needs to be modified. As with the infinite line example, assume that each new line segment is made up of an infinite number of data points. If we again calculate the distance between a new data point Z and each of these infinite points on the line segment, and then apply the same Gaussian kernel and summation, we have the equivalent of the integration of the shaded region in either FIG. 4A or 4B. FIG. 4A represents the integration that will occur for an inside point and FIG. 4B represents the integration that will occur for an outside point. A point is defined as an inside point if a line may be drawn orthogonally to the line segment that intersects both the line and the point. The point is otherwise considered an outside point.

Three distances are necessary in order to calculate the shaded region in either FIG. 4A or 4B, as shown in FIG. 2A, where distances a and c represent the distance to each of the line end points and line b represents the perpendicular distance to the line segment. The integration to be applied to the hybrid model may then be calculated for an inside point as

φ_{IC}[2Q(b)−Q(a)−Q(c)], (10)

where

$$Q ( d ) = \frac{2}{σ \sqrt{2 π}} {\int }_{d}^{∞} {e}^{( - \frac{{x}^{2}}{2 {σ}^{2}} )} d x . \qquad ( 11 )$$

For the integration for an outside point, point b can be disregarded as seen in FIGS. 2A and 4B. The integration is calculated as

φ_{IC}=|Q(a)−Q(c)|. (12)

Finally, the new class probabilities are calculated as before by modifying Equation 9 as follows,

$$P ( Class ) = \frac{{\sum }_{m} {w}_{m} {φ}_{m} + \frac{2}{σ \sqrt{2 π}} {\sum }_{k} {w}_{k} {e}^{( \frac{- {D}_{k}^{2}}{2 {σ}^{2}} )}}{{\sum }_{j} {ω}_{j} {φ}_{j} + \frac{2}{σ \sqrt{2 π}} {\sum }_{i} {e}^{( \frac{- {D}_{i}^{2}}{2 {σ}^{2}} )}} , \\ {w}_{m} = \{ \begin{matrix}{ω}_{m} & Class ∈ m \\ 0 & Class ∉ m\end{matrix} , \qquad ( 13 )$$

where j and m are now all model segments representing faults.

With this modification, the new model may easily represent non-linear faults with a piece-wise linear set of line segments. Additionally, if two faults have a similar effect on the engine (i.e. the fault ICs are both in the same direction), the two faults may now be better distinguished by the fault magnitude expected for each fault. With the existing infinite line representation both faults would be nearly indistinguishable as both lines would necessarily overlap.

The process by which a new data point is processed through the new hybrid fault isolator is diagrammed in FIG. 2B.

As shown in FIG. 1, as engine 22 operates, sensor readings and information are generated. A control 23 for the fault isolation system takes in those readings. As shown, a current fault is initialized for each loop.

A database 24 is queried to determine a model-based prediction based upon the sensed information and resultant calculated vector readings. Each of the distances a, b, and c are calculated from each of the fetched model line segments (as illustrated in FIG. 2A). Weights to be applied can then be calculated from the model-based fault isolation portion of the system, as in Equations 10 and 12 for inside and outside points respectively in relation to each fault model segment

Then, the database 24 is queried to retrieve past actual fault examples. The fault weights from each of the past examples associated with the CURRENT_FAULT are calculated using the distance between each past example and the unknown input point.

The weights from both the model-based and the actual past fault examples are then added. At that point, if all the potential faults have had their weights calculated, the method proceeds to a calculation of probabilities. On the other hand, if additional potential faults can be considered, the loop will continue with consideration of the next potential fault.

Once all potential faults have been considered, probabilities can be generated based upon the total weights of all of the faults as shown in the flow chart of FIG. 2B. The most likely fault, or faults, may then be outputted and directed to display at 26 to maintenance personnel. Display 26 could be a computer screen and the computer screen could include the database 24 as well as the control 23.

By utilizing the weights of both the model-based portion of the system and the actual examples, this method will allow the isolation system to improve its ability to predict faults accurately when revenue service data becomes available, but will also closely match the performance of the assumed model in the absence of such data. That is, a model-based solution alone is able to make predictions early in the operation of a particular engine, but may not be as accurate as actual examples will eventually become. On the other hand, especially early in operation of an engine, there is limited actual fault information available. The present invention, by combining both systems, will more quickly get to accurate predictions.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A fault diagnosis system comprising:
a system for taking in readings from a plurality of sensors associated with a gas turbine engine;
said plurality of sensors providing readings to the system, said system comparing said readings to predicted faults using a model-based fault isolation system, and a database of previous actual fault examples being queried to compare said readings; and
said fault isolation system providing a predicted fault to an output based upon both said model-based fault isolation system and said actual fault examples.

2. The system as set forth in claim 1, wherein weights are calculated for both the model-based fault predictions and the actual fault examples, and the weights are combined to provide a total weight for each of a plurality of potential faults.

3. The system as set forth in claim 2, wherein a combined weight for each of said plurality of potential faults is calculated in a loop until all potential faults have weights calculated.

4. The system as set forth in claim 3, wherein probabilities are generated based upon the combined weights from each of the potential fault examples.

5. The system as set forth in claim 4, wherein a most likely fault is sent as an output after the probabilities have been determined.

6. The system as set forth in claim 5, wherein the most likely fault is displayed to a maintenance personnel.

7. The system as set forth in claim 1, wherein the system determines the predicted fault utilizing the following equation:
$$P ( Class ) = \frac{{\sum }_{m} {w}_{Class} {φ}_{Class} + \frac{1}{σ \sqrt{2 π}} {\sum }_{k} {e}^{( \frac{- {D}_{k}^{2}}{2 {σ}^{2}} )}}{{\sum }_{j} {ω}_{j} {φ}_{j} + \frac{1}{σ \sqrt{2 π}} {\sum }_{i} {e}^{( \frac{- {D}_{i}^{2}}{2 {σ}^{2}} )}} ,$$
where P(Class) is the probability of each fault class, D² is the squared distance to an empirical data point, the subscript k represents all empirical data points of fault Class, subscript i represents all empirical data points, subscript j represents all model vectors, and ω is a weighting factor applied to each of the model vectors, φ.

8. The system as set forth in claim 7, wherein the system further determines the predicted fault utilizing the following equation:
$$P ( Class ) = \frac{{\sum }_{m} {w}_{m} {φ}_{m} + \frac{2}{σ \sqrt{2 π}} {\sum }_{k} {w}_{k} {e}^{( \frac{- {D}_{k}^{2}}{2 {σ}^{2}} )}}{{\sum }_{j} {ω}_{j} {φ}_{j} + \frac{2}{σ \sqrt{2 π}} {\sum }_{i} {e}^{( \frac{- {D}_{i}^{2}}{2 {σ}^{2}} )}} , \\ {w}_{m} = \{ \begin{matrix}{ω}_{m} & Class ∈ m \\ 0 & Class ∉ m\end{matrix} ,$$
where j and m are all model segments representing faults.

9. A method of operating a fault diagnosis system including the steps of:
(a) taking sensor readings from a gas turbine engine;
(b) providing the readings to a system, said system comparing said readings to predicted faults using a model-based fault isolation system, and a database of previous actual fault examples being queried to compare said readings; and
(c) providing a predicted fault to an output based upon both said model-based fault isolation system and said actual fault examples.

10. The method as set forth in claim 9, wherein weights are calculated for both the model-based fault predictions and the actual fault examples, and the weights are combined to provide a total weight for each of a plurality of potential faults.

11. The method as set forth in claim 10, wherein a combined weight for each of said plurality of potential faults is calculated in a loop until all potential faults had weights calculated.

12. The method as set forth in claim 11, wherein probabilities are generated based upon the combined weights from each of the potential fault examples.

13. The method as set forth in claim 12, wherein a most likely fault is sent as an output after the probabilities have been determined.

14. The method as set forth in claim 13, wherein the most likely fault is displayed to a maintenance personnel.

15. The method as set forth in claim 9, wherein the fault is predicted utilizing the following formula:
$$P ( Class ) = \frac{{w}_{Class} {φ}_{Class} + \frac{1}{σ \sqrt{2 π}} {\sum }_{k} {e}^{( \frac{- {D}_{k}^{2}}{2 {σ}^{2}} )}}{{\sum }_{j} {ω}_{j} {φ}_{j} + \frac{1}{σ \sqrt{2 π}} {\sum }_{i} {e}^{( \frac{- {D}_{i}^{2}}{2 {σ}^{2}} )}}$$
where P(Class) is the probability of each fault class, D² is the squared distance to an empirical data point, the subscript k represents all empirical data points of fault Class, subscript i represents all empirical data points, subscript j represents all model vectors, and ω is a weighting factor applied to each of the model vectors, φ.
